(19) United States
(12) Patent Application Publication
(10) Pub. No.: US 2014/0255135 A1
(43) Pub. Date: Sep. 11, 2014

(54) TOW BAR ATTACHMENT

(71) Applicant: LIFTOW RIDE PTY LTD, Maitland (AU)

(72) Inventor: Wayne Yorke Roe, Maitland (AU)

(73) Assignee: LIFTOW RIDE PTY LTD, Maitland (AU)

(21) Appl. No.: 14/200,807

(22) Filed: Mar. 7, 2014

(30) Foreign Application Priority Data
Mar. 8, 2013 (AU) 2013900813

(51) Int. Cl. B60P 1/44

(52) U.S. Cl. CPC B60P 1/44
USPC 414/462

(57) ABSTRACT

A tow bar attachment (10) having a holder (11) mounted thereon the tow bar attachment (10) is intended to be mounted on a towing vehicle such that the tow bar attachment (10) is fixed thereto. The holder (11) is adapted to carry a front wheel (12) of a two-wheeled vehicle (motor bike).

### FIELD

The present invention relates broadly to attachments at the back of vehicles, and more particularly but not exclusively to attachments for vehicle tow bars.

### BACKGROUND

A tow bar attachment is an apparatus mounted to the back of a vehicle to securely mount and carry at least a part of, or the entire object to be towed.

A conventional tow bar attachment for carrying, e.g. a motorcycle, typically includes a raised platform, which may be mounted on wheels, and a ramp leading from the ground to the platform. To load, the motorcycle must be pushed up the ramp and onto the platform where it is secured by clamps and/or cables, etc. This can be cumbersome for a single operator especially when loading a heavy motorcycle, as he would be on the ground while the motorcycle is already on the platform. The operator needs to balance the motorcycle to prevent it from toppling or sliding backward while also trying to get onto the platform to secure the motorcycle. Thus, at least two operators are normally required.

Another disadvantage of known tow bar attachments is that they are generally adapted to suit a certain type of object to be towed. Accordingly, a conventional tow bar attachment needs to be completely replaced in order to tow or carry a different object.

### OBJECT

It is the object of the present invention to overcome or substantially ameliorate the above disadvantages, or to provide a useful alternative.

### SUMMARY

There is disclosed herein an attachment for a vehicle tow bar, the attachment including:

an upwardly extending base;

a connector fixed to the base for mounting the attachment to the tow bar so that the attachment can be supported by the tow bar, the connector being fixed to the base at a fixed location;

a carrier movably mounted on the base for movement relative thereto between a lowered position and a raised position, the carrier having a lower portion which when in the lowered position is lower than the fixed location; and

an actuator mounted on the base and operably associated with the carrier to move the carrier between the lowered position and the raised position.

Preferably, the carrier is configured to receive a holder releasably mounted on the lower portion of the carrier, the holder supporting an object to be towed or carried.

Preferably, the holder is at substantially ground level when the carrier is at the lowered position.

Preferably, the base includes a hollow outer tube, and the carrier includes a hollow inner tube disposed within the outer tube so as to be slidably guided by the outer tube during movement between the raised and lowered positions.

Preferably, the outer and inner tubes have square cross-sections.

Preferably, the attachment further includes at least one reinforcement member fixed to both the connector and the base for strengthening a joint between the connector and the base at the fixed location.

Preferably, the base is substantially orthogonal to the connector.

Preferably, the actuator includes a winch.

Preferably, the winch is a strap winch having a retractable strap coupled to the carrier for moving the carrier between the lowered and raised positions.

Preferably, the attachment further includes an electric motor coupled to the actuator for driving the actuator.

Preferably, the attachment further includes a key configured to engage with the base and the carrier for securing the carrier to the base at the raised position.

Preferably, the connector is extendable.

Preferably, the outer tube comprises a top end and a bottom end, the fixed location being adjacent to the bottom end.

Preferably, a portion of the bottom end of the outer tube opposite the connector is removed for exposing the lower portion of the inner tube.

Preferably, wherein the holder is releasably mounted to the inner tube at an exposed lower portion of the inner tube.

### BRIEF DESCRIPTION OF DRAWINGS

A preferred form of the present invention will now be described by way of example with reference to the accompanying drawings wherein:

FIG. 1 is a schematic plan view of a tow bar attachment having a holder mounted thereon according to an example embodiment;

FIG. 2 is a schematic partially sectioned front elevation of the tow bar attachment of FIG. 1;

FIG. 3 is schematic side elevation of the tow bar attachment of FIG. 1;

FIG. 4 is a schematic partially sectioned view of the connector shown in FIG. 3;

FIG. 5 is a schematic side view of the tow bar attachment of FIG. 1 together with a two-wheeled vehicle in a towing position;

FIG. 6 is a schematic side view of the tow bar attachment of FIG. 1 in an example use for transporting an auxiliary box or extra boot;

FIG. 7 is a schematic side view of the tow bar attachment of FIG. 1 in another example use for lifting and carrying a weight;

FIG. 8 is a schematic side view of the tow bar attachment of FIG. 1 in another example use for carrying a two-wheeled vehicle in a transverse direction; and

FIG. 9 is a schematic side view of the tow bar attachment of FIG. 1 in another example use for operating as a forklift or jack.

### DESCRIPTION OF EMBODIMENTS

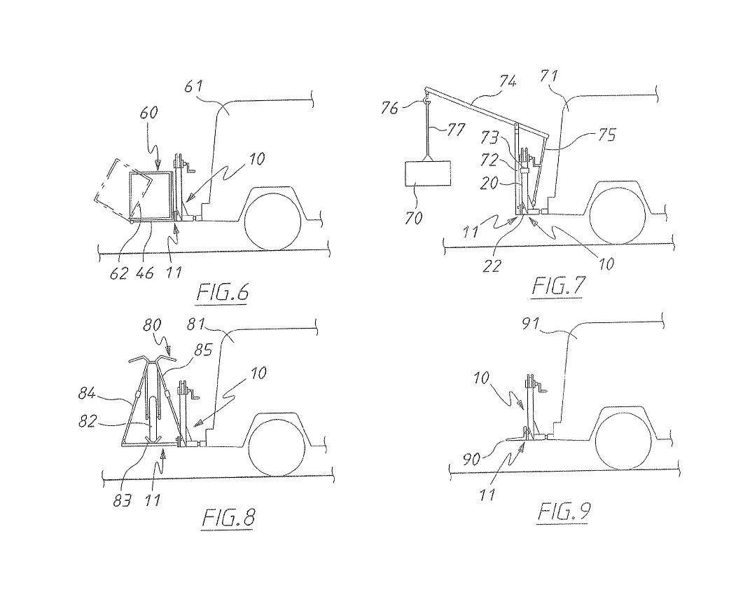

In FIGS. 1 to 4, a tow bar attachment 10 having a holder 11 mounted thereon is depicted. The tow bar attachment 10 is intended to be mounted to a towing vehicle (not shown) such that the tow bar attachment 10 is fixed to, and supported by the towing vehicle. The tow bar attachment 10 is also capable of receiving different holders carrying respective types of objects to be carried or towed. In the example of FIGS. 1 to 4, the holder 11 is adapted for carrying a wheel, e.g. a front wheel 12, of a two-wheeled vehicle 13 (FIG. 5). However, as shown in FIGS. 6-9 and as will be appreciated by a person skilled in the art, other holders may be used in alternate embodiments, depending on e.g. usage requirement.

The tow bar attachment 10 includes a connector 14 that connects with a standard tow bar receiver (not shown) disposed at the back of the towing vehicle, for mounting and supporting the weight of the tow bar attachment 10 and an object to be towed or carried (not shown). As shown in FIGS. 1, 3 and 4, the connector 14 has a proximal end 15 and a distal end 16, where the distal end 16 is adapted to engage with the tow bar receiver. For example, if the tow bar receiver has a square opening, the distal end 16 has a square cross-section that securely fits into the opening.

FIG. 4 shows a schematic partially section view of the connector 14 showing that the connector 14 is extendable. In this implementation, the proximal end 15 is on a tube 17, while the distal end 16 is on a standard adaptor beam 18 that is slidable relative to the tube 17. Once a desired length of the connector 14 is attained, the adaptor beam 18 is secured to the tube 17 by inserting e.g. a pin into the through hole 19. Other implementations are possible to allow the connector 14 to be extendable.

Referring back to FIGS. 1 to 3, the proximal end 15 of the connector 14 is fixedly attached to an upwardly extending base 20 at a fixed location 21 (FIG. 3), e.g. by welding or similar means. The fixed location 21 is disposed at a predetermined height from the ground, depending on e.g. the type and configuration of the towing vehicle. The longitudinal axis of the base 20 is substantially orthogonal to that of the connector 14, such that the base 20 is approximately vertical if the connector 14 is disposed horizontally. A carrier 22 is movably mounted on the base 20, e.g. in a sliding engagement, such that the carrier 22 is movable relative to the base 20 between e.g. a lowered (i.e. loading) position and a raised (i.e. towing or carrying) position. In some implementations, longitudinal axes of the base 20 and carrier 22 are parallel.

In a preferred embodiment, the base 20 is in the form of a hollow outer tube, while the carrier 22 is in the form of a hollow inner tube disposed within the outer tube, as more clearly shown in FIG. 1. The carrier 22 thus can slide against an inner surface of the base 20. The hollow tubes can provide a compact arrangement as well as sufficient flexural strength. In the implementation shown in FIGS. 1 to 4, the inner tube and outer tube have square cross-sections, for example, rolled hollow sections (RHS) of dimensions 75 mm×75 mm×4.0 mm and 65 mm×65 mm×4.0 mm, respectively, and a mast height of about 700 mm. It will be appreciated that other hollow cross-sections such as rectangular, elliptical, circular, etc. may be used in other implementations. The square cross-sections can provide ease of assembly compared to e.g. rectangular cross-sections.

In alternate embodiments, the base 20 and carrier 22 may take different forms while maintaining sliding engagement with each other. For example, the carrier 22 can be in the form of a C-beam that is slidably engaged with the base 20 in the form of an I-beam or H-beam.

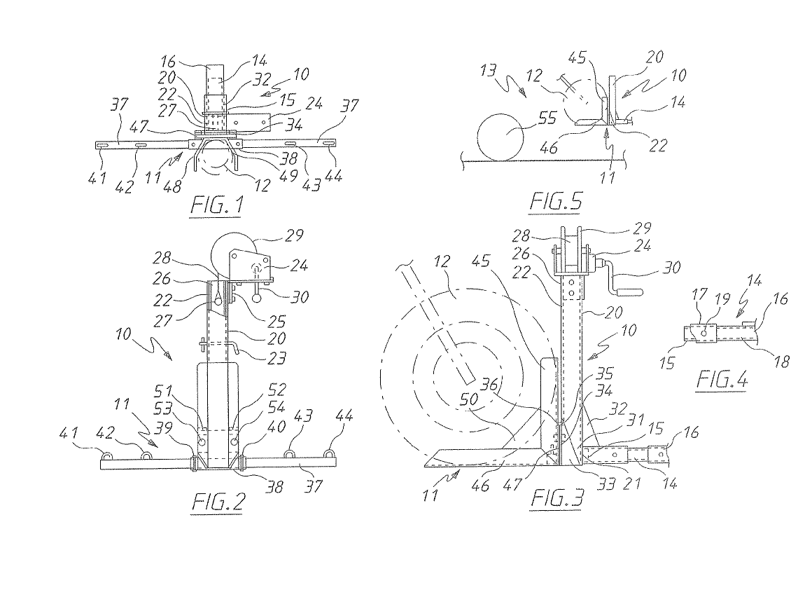

As shown in FIGS. 1-4, the carrier 22, thereby the holder 11, is in the towing or carrying position where the holder 11 is substantially level with the connector 14. A key 23 (FIG. 2), e.g. pin, is inserted through the cross-sections base 20 and carrier 22 to secure the carrier 22 relative to the base 20 in the towing or carrying position. The size and material of the key or pin 23 can be determined based on e.g. the weight of carrier 22, the weight of the holder 11 and the maximum weight of the object to be towed or carried.

An actuator in the form of a strap winch 24 is mounted on the base 20 for moving the carrier 22 between the loading and towing/carrying positions. For example, a support plate 25 (FIG. 2) is provided at a top end 26 of the base 20 for receiving the strap winch 24. The carrier 22 includes a fixed pin 27 to which a strap 28 of the strap winch 24 is fastened, as can be seen in the sectioned portion in FIG. 2. The strap winch 24 includes a spool 29 on which the strap 28 can be coiled or wrapped. The spool 29 is driven by a crank 30. By turning the crank 30 in one direction, e.g. clockwise, the strap 28 is retracted and the carrier 22 is raised. Similarly, by turning the crank 30 in the opposite direction, e.g. anti-clockwise, the strap 28 is released and the carrier 22 is lowered by gravity.

In alternate embodiments, other mechanical actuators including one or more of gears, cams, chains, pulleys, belts, etc. may be used in place of the strap winch 24. Also, an electric motor (not shown) may be coupled to the strap winch 24 to replace and/or assist manual turning during lowering and raising of the carrier 23, in a manner that will be appreciated by a person skilled in the art.

As illustrated more clearly in FIG. 3, the base 20 is mounted to the connector 14 adjacent to its bottom end 31. This can help to increase the height available (i.e. clearance from the ground) for raising the carrier 22, hence the holder 11. At least one reinforcement member in the form of a gusset plate 32, is fixed, e.g. by welding, to the connector 14 and the base 20 to strengthen the joint at the fixed location 22. Alternatively, a bracket, a strengthening bar, or other reinforcement parts can be used.

Moreover, a portion of the bottom end 31 of the base 20 (outer tube) opposite the connector 14 is removed, thereby exposing a lower portion 33 of the carrier 22 (inner tube). In an implementation, the removal may be carried out by cutting away a triangular portion from the bottom end 31. The removed triangular portion can be re-used for the gusset plate 32.

At the lower portion 33 of the carrier 22 (inner tube) thus exposed, mounting means in the form of at least one mounting plate 34 is attached. The mounting plate 34 has a width that is larger than the width of the base 20 (outer tube). For example, the mounting plate 34 can be of dimensions 150 mm width×150 mm height for an outer tube of 75 mm width. When the carrier 22 (inner tube) is raised to the towing position, a top surface 35 (FIG. 3) of mounting plate 34 abuts an edge 36 (FIG. 3) of the base 20 (outer tube) formed by removing the bottom portion. The carrier 22 is thus prevented from further upward movement. When the carrier 22 is in the lowered position, the lower portion 33 is lower than the fixed location 21 (FIG. 3). In preferred implementations, the holder 11 attached to the lower portion 33 of the carrier 22 is at substantially ground level when the carrier 22 is in the lower position.

The holder 11 in the example embodiment includes an elongated beam 37 inserted into a shorter pocket 38 such that the pocket 38 is positioned at a middle section of the elongated beam 37. For example, the elongated beam 37 is a RHS of dimensions 35 mm×35 mm×2.5 mm, while the pocket 38 is a RHS of dimensions 40 mm×40 mm×2.0 mm. The length of the beam 37 may vary depending on the object to be towed. Fastening means 39, 40 (FIG. 2), e.g. pins, screws or rivets, can be used to secure the elongated beam 37 relative to the pocket 38. A plurality of chain links 41, 42, 43, 44, e.g. welded hooks, are also provided on the elongated beam 37 for securing the object to be towed to the elongated beam 37, if necessary.

The pocket 38 is further attached to metal plates 45, 46, which support the object to be towed, and to a back plate 47. As illustrated in FIG. 1, the metal plates 45, 46 have splayed sides 48, 49 (FIG. 1) which are disposed at an angle rather than orthogonal to the back plate 47, to accommodate tyres of different diameters, e.g. 90 mm or 120 mm, while minimising any lateral movement of the wheel 12. For carrying the wheel 12, the length of the bottom plate 46 is typically greater than the radius of the wheel 12. In addition, gusset plates 50 or other strengthening parts may be welded between the top plate 45 and the bottom plate 46 to strengthen the holding capacity of the bottom plate 46.

The back plate 47 is configured to engage with the mounting plate 34, thereby securing the holder 11. For example, mounting hooks 51, 52 disposed at the top of the back plate 47 adjacent to the top corners can latch over the top surface 35 of the mounting plate 34. In addition, through holes on the back plate 47 can match with corresponding through holes on the mounting plate 34, and bolts 53, 54 can be inserted therethrough. To remove the holder 11 from the tow bar attachment 10, e.g. to replace with a different holder, the bolts 53, 54 can be removed and the holder 11 is lifted to dislodge the hooks 51, 52.

FIG. 5 shows the tow bar attachment 10 as described above with respect to FIGS. 1 to 4 in use with a two-wheeled vehicle 13, e.g. a motorcycle or a bicycle, partially illustrated here by a front wheel 12 and a back wheel 55. In order to load the vehicle 13, the carrier 22, together with the holder 11 mounted thereon, is lowered to the lowered position by releasing the strap 28 of the strap winch 24 (FIGS. 2 and 3) such that the holder 11 rests on the ground. The vehicle 13 is pushed into the holder 11 until the front wheel 12 rests on the bottom plate 46. The front wheel 12 is then clamped or secured to the holder 11 in one or more ways as understood in the art by utilising structure of the holder 11. An operator carrying out the loading can remain on the ground during the above steps. Once secured, the holder 11 is raised from the ground by retracting the strap 28 of the strap winch 24 such that only the back wheel 55 of the vehicle 13 remains on the ground. The key 23 (FIG. 2) is inserted through the base 20 and carrier 22 when the front wheel 13 has been lifted to the desired height. The vehicle 13 can then be towed with its back wheel 55 rolling.

The tow bar attachment 10 is not limited to the use described with respect to FIG. 5. FIG. 6 shows an alternate use of the tow bar attachment 10 for carrying an auxiliary box or extra boot 60. The tow bar attachment 10 is mounted to a towing vehicle 61. Here, the holder 11 is adapted to accommodate the width and length of the box or boot 60. The box or boot 60 can be loaded onto the holder 11 e.g. by tilting it and inserting a bottom plate 46 of the holder 11 underneath the tilted bottom surface 62. Subsequent operations are similar to those described above with respect to FIG. 5, except that the weight of the whole box or boot 60 is supported by the tow bar attachment 10.

FIG. 7 shows another alternate use of the tow bar attachment 10 for lifting and carrying an object 70. The tow bar attachment 10 is mounted to a towing vehicle 71. Here, the holder 11 is adapted to include a supporting column 72, which is secured to the carrier 22 (inner tube) at its bottom section. The middle section of the supporting column 72 is coupled to the base 20 (outer tube) by e.g. a sleeve or bracket 73 that keeps the column 72 substantially vertical while allowing the column 72 to move up or down. An elongated beam 74 is pivotally coupled, at its middle section, to the top end of the supporting column 72. One end of the beam 74 is coupled to a rope or chain 75, which is secured to the tow bar attachment 10. The opposite end of the beam 74 is coupled to a hook 76, which can engage with one end of a cable 77, while the other end of the cable 77 is secured to the weight 70.

To lift the weight 70, the supporting column 72 is lowered until the cable 77 can be put over the hook 76, e.g. through a cable loop. The supporting column 72 is then raised by raising the carrier 22 such that the cable 77 becomes taut and the weight 70 leaves the ground. Once the weight 70 is at the desired height, the key 23 (FIG. 2) can be inserted to secure the inner tube relative to the outer tube, and the weight 70 can be carried off to a different location. In an example implementation, the weight 70 can be up to 100 kg and can be lifted up to 1.0 m from the ground.

FIG. 8 shows yet another use of the tow bar attachment 10 for transporting a two wheeled vehicle 80, such as a motorcycle or a bicycle, in a transverse direction with respect to length of a towing vehicle 81. Here, the holder 11 is adapted to allow both wheels 82 of the vehicle 81 to rest on the holder 11, e.g. by having two transverse supporting plates 83. In addition, the holder 11 may be extended to provide a plurality of points where securing cables 84, 85 attached to the vehicle 80 can be mounted. In this implementation, the whole vehicle 80 can be carried at a height from the ground. This can be useful in situations where both wheels of the vehicle 80 are damaged.

FIG. 9 shows a further use of the tow bar attachment 10, here as a forklift or jack. The holder 11 can be adapted to include a fork 90 protruding in a backward direction relative to a towing vehicle 91. For example, the fork 90 can be inserted underneath a pallet or crate (not shown) to lift and move the pallet or crate to a different location, where the pallet or crate can be lowered and released. Alternatively, the fork 90 can lift a pallet or crate from the ground and place the pallet or crate at a higher position.

The tow bar attachment according to the example embodiments allow different objects to be towed or carried by changing the holder, and not the entire tow structure. Moreover, the tow bar attachment can be fitted to standard tow bar receivers currently available. Thus, versatility can be achieved at a lower cost than existing devices. In addition, by allowing the holder to be lowered on to the ground, loading can be made easier, and can be carried out by a single operator.

1. An attachment for a vehicle tow bar, the attachment including:
an upwardly extending base;
a connector fixed to the base for mounting the attachment to the tow bar so that the attachment can be supported by the tow bar, the connector being fixed to the base at a fixed location;
a carrier movably mounted on the base for movement relative thereto between a lowered position and a raised position, the carrier having a lower portion which when in the lowered position is lower than the fixed location; and
an actuator mounted on the base and operably associated with the carrier to move the carrier between the lowered position and the raised position.

2. The attachment of claim 1, wherein the carrier is configured to receive a holder releasably mounted on the lower portion of the carrier, the holder supporting an object to be towed or carried.

3. The attachment of claim 2, wherein the holder is at substantially ground level when the carrier is at the lowered position.

4. The attachment of claim 1, wherein the base includes a hollow outer tube, and the carrier includes a hollow inner tube disposed within the outer tube so as to be slidably guided by the outer tube during movement between the raised and lowered positions.

5. The attachment of claim 4, wherein the outer and inner tubes have square cross-sections.

6. The attachment of of claim 1, further including at least one reinforcement member fixed to both the connector and the base for strengthening a joint between the connector and the base at the fixed location.

7. The attachment of claim 1, wherein the base is substantially orthogonal to the connector.

8. The attachment of claim 1, wherein the actuator includes a winch.

9. The attachment of claim 8, wherein the winch is a strap winch having a retractable strap coupled to the carrier for moving the carrier between the lowered and raised positions.

10. The attachment of claim 1, further including an electric motor coupled to the actuator for driving the actuator.

11. The attachment of claim 1, further including a key configured to engage with the base and the carrier for securing the carrier to the base at the raised position.

12. The attachment of claim 1, the connector is extendable.

13. The attachment of claim 4, wherein the outer tube comprises a top end and a bottom end, the fixed location being adjacent to the bottom end.

14. The attachment of claim 4, wherein a portion of the bottom end of the outer tube opposite the connector is removed for exposing the lower portion of the inner tube.

15. The attachment of claim 4, wherein the holder is releasably mounted to the inner tube at an exposed lower portion of the inner tube.

16. The attachment of claim 3, wherein the base includes a hollow outer tube, and the carrier includes a hollow inner tube disposed within the outer tube so as to be slidably guided by the outer tube during movement between the raised and lowered positions.

17. The attachment of of claim 6, further including at least one reinforcement member fixed to both the connector and the base for strengthening a joint between the connector and the base at the fixed location.

18. The attachment of claim 6, the base is substantially orthogonal to the connector.

19. The attachment of claim 10, further including a key configured to engage with the base and the carrier for securing the carrier to the base at the raised position.

20. The attachment of claim 11, wherein the connector is extendable.
